(19) United States
(12) Patent Application Publication
(10) Pub. No.: US 2002/0003391 A1
(43) Pub. Date: Jan. 10, 2002

(54) Discharge lamp device and an insulating plug therefor

(76) Inventors: Toshiaki Tsuda, Shizuoka (JP); Masaya Shido, Shizuoka (JP); Michio Takagaki, Shizuoka (JP)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/899,281

(22) Filed: Jul. 6, 2001

(30) Foreign Application Priority Data
Jul. 7, 2000 (JP) P2000-207336

(51) Int. Cl. H01J 5/48

(52) U.S. Cl. 313/318.01

(57) ABSTRACT

An insulating plug, for a discharge lamp device, including a plug body and a lamp-side connector. The plug body is made of a glass-fiber-reinforced plastic resin. The lamp-side connector is provided at a rear end portion of the plug body. A power-supplying connector can be attached to, and detached from, the lamp-side connector. The plug body has an arc tube fixedly held thereon, so as to form a discharge lamp device. Because the plug body is made of a glass-fiber-reinforced plastic resin, the durability, molding precision, and so on of the plug body and, hence, those of the discharge lamp device provided with this plug body, are enhanced.

### BACKGROUND OF THE INVENTION

1. Field of the Invention

This invention relates to an improved insulating plug, for a discharge lamp device, including a synthetic resin-made plug body having an arc tube fixedly held at a front end portion thereof, wherein a lamp-side connector—relative to which a power-supplying connector can be attached and detached—is provided integrally at a rear end portion of the synthetic resin-made plug body.

2. Description of the Related Art

In recent years, “a discharge lamp device”, in which light is emitted by a discharge phenomenon developing between opposed electrodes in a glass bulb having xenon gas sealed therein, has been extensively used in vehicle lamps such as an automotive headlamp.

The structure of this discharge lamp device will be briefly described. It comprises an insulating plug having a synthetic resin-made plug body, an arc tube, and a lamp-side connector. The insulating plug's body is obtained by injection molding it into a predetermined shape, using various synthetic resins. The arc tube is fixedly held at a front end portion of this plug body. The lamp-side connector—relative to which a power-supplying connector can be attached and detached—is provided integrally at a rear end portion of the plug body.

The arc tube has a light emitting portion disposed in a sealed space (also called a sealed chamber) obtained by pinch sealing opposite ends of an elongate glass tube at a predetermined interval. Opposed discharge electrodes, made of tungsten, are disposed in this light emitting portion. Also, starter rare gas, mercury and a metal halide are sealed in the light emitting portion.

A shroud glass tube is provided, mainly, for the purpose of cutting an ultraviolet component wavelength range which is contained in the light emitted from this light emitting portion, which ultraviolet component is harmful to a human body. The shroud glass tube is of a generally cylindrical shape that seals the arc tube by enveloping it, and forms the above-noted sealed space. This shroud glass tube is supported by a lead support, which is fixedly secured to the plug body, and which projects forwardly.

In the discharge lamp device of this construction, the plug body forms a base portion that is provided in the vicinity of the arc tube. And the arc tube is provided with the light emitting portion. Therefore, the plug body is exposed to a high-temperature condition of 220° C., and a high voltage of about 20 kV, at the time of starting the discharge lamp device.

The plug body is the portion which is inserted in a lamp body, and also is the portion on which the lamp-side connector—relative to which the power-supplying connector can be attached and detached—is mounted. Therefore, a load is applied to this plug body when it is inserted and detached from the lamp body. Further, a high dimensional accuracy is required for the plug body.

Although the plug body of the conventional discharge lamp device has been required to have high durability, rigidity, and moldability, heretofore a single synthetic resin material has been used. Therefore, the plug body has been insufficient in heat resistance, lifetime durability, connector fitting strength (also called rigidity), moldability (also called dimensional accuracy), and so on.

Therefore, a technical problem has been to provide a plug body having all of these quality conditions. Further, it has been increasingly desired that the cost of the discharge lamp devices, which are more expensive as compared with halogen lamps and the like, should be reduced.

### SUMMARY OF THE INVENTION

It is an object of this invention to enhance the quality and performance required for a plug body that forms a base portion of a discharge lamp device, and also to reduce its cost.

In order to achieve the above and other objects, the present invention provides an insulating plug for a discharge lamp device wherein a lamp-side connector—relative to which a power-supplying connector can be attached and detached—is provided at a rear end portion of a plug body and an arc tube is fixed to the front of the plug body, wherein the plug body is made of a glass-fiber-reinforced plastic.

Therefore, the heat resistance, lifetime durability, and connector fitting strength, of the plug body, which has heretofore been made of a single synthetic resin, are enhanced. Further, cost reduction is achieved.

By adopting a polyphenylene sulfide resin (hereinafter referred to as “PPS resin”) as the base synthetic resin of the glass-fiber-reinforced plastics material to be used, the moldability and the recycling ability are enhanced.

By limiting the content of the glass fibers in the PPS resin to the range of from 20 weight % to 80 weight %, the durability required for the insulating plug is secured. Further, a weld crack and the lowering of moldability, which would be caused by the excess content of the glass fibers, are prevented. Weld crack means a crack that develops at a boundary portion (or weld), facing a gate position, when the resin—injected and filled from a predetermined position during the injection molding of the cylindrical insulating plug body, having a central bore—surrounds the central bore portion.

Therefore, in the insulating plug of the present invention, the overall durability of the plug body, which has heretofore had problems, is improved. Also, the discharge lamp device, which is provided with this insulating plug, is enhanced in durability.

### BRIEF DESCRIPTION OF THE DRAWINGS

The above and other objects and advantages of the present invention will become more apparent by describing in detail preferred exemplary embodiments thereof with reference to the accompanying drawings, wherein like reference numerals designate like or corresponding parts throughout the several views, and wherein:

FIG. 1 is a perspective view of a discharge lamp device (1) adopting an insulating plug (2) of the present invention;

FIG. 2 is a side-elevational view of the discharge lamp device (1);

FIG. 3 is an exploded, perspective view of an arc tube perpendicularly-holding member (5);

FIG. 4 is a graph showing results of a test (Test 1) for heat resistance;

FIG. 5 is a graph showing results of a test (Test 2) for lifetime durability;

FIG. 6 is a graph showing results of a test (Test 3) for connector fitting strength (rigidity);

FIG. 7 is a graph showing results of a test (Test 4) for dimensional accuracy (also called moldability); and

FIG. 8 is a table collectively showing the results of Tests 1 to 4.

### DETAILED DESCRIPTION OF THE PREFERRED EMBODIMENTS

An embodiment of the present invention will now be described with reference to the accompanying drawings.

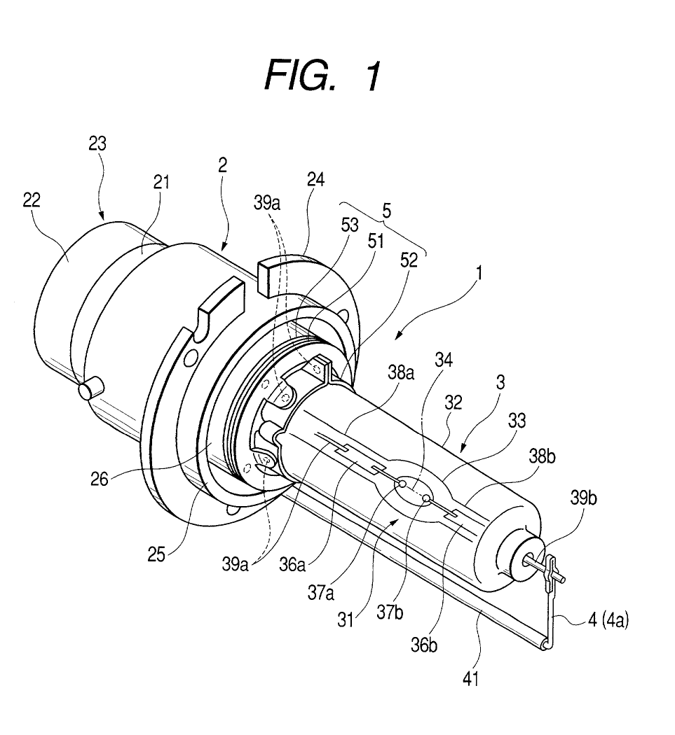

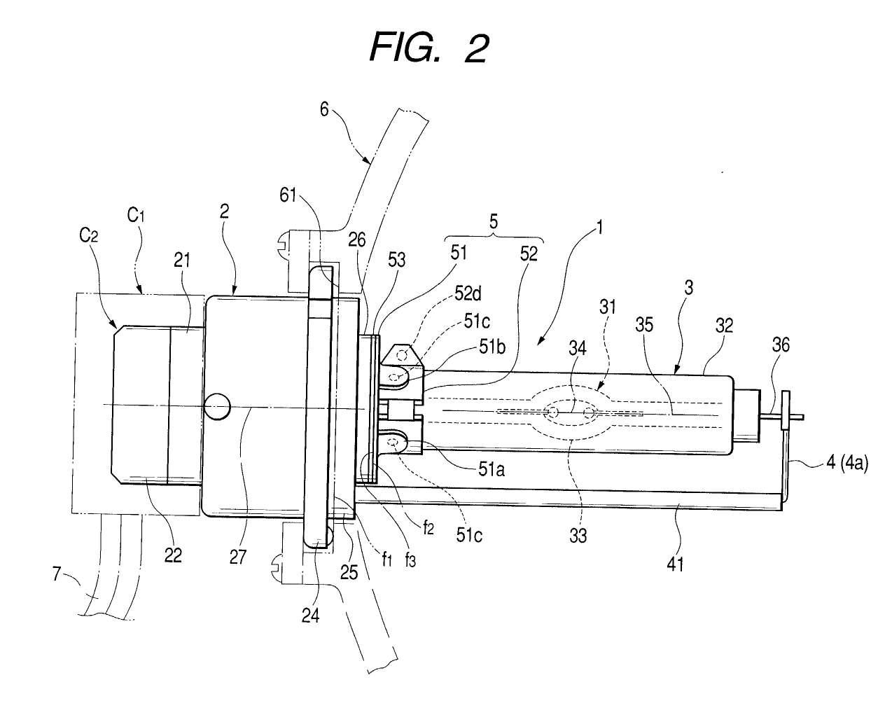

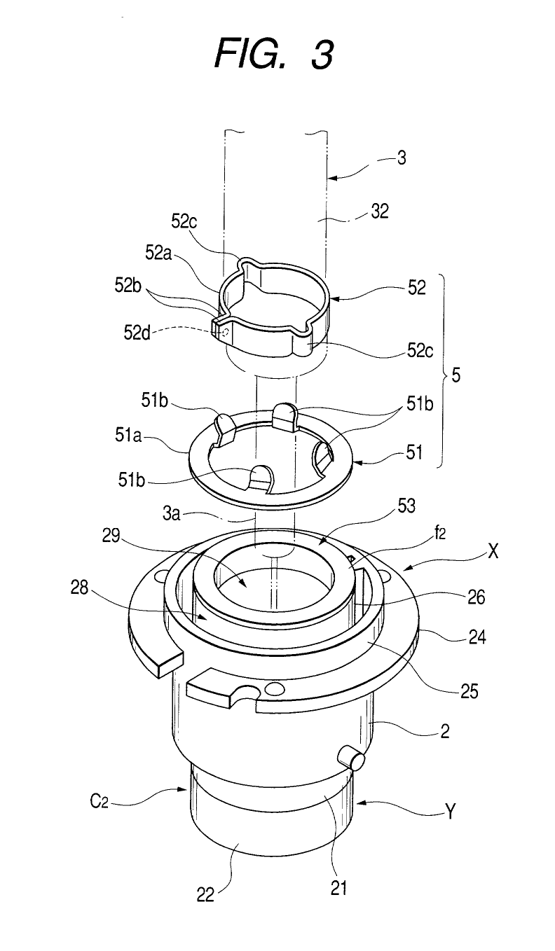

FIGS. 1-3 show an embodiment of the invention, wherein FIG. 1 is a perspective view of a discharge lamp device employing an insulating plug of this invention, FIG. 2 is aside-elevational view of the discharge lamp device, and FIG. 3 is an exploded, perspective view of an arc tube perpendicularly-holding member.

Overall Construction of Discharge Lamp Device

The overall construction of the discharge lamp 1 of this invention will first be described with reference to FIGS. 1 to 3. In these Figures, reference numeral 1 denotes the discharge lamp device as a whole, reference numeral 2 denotes the insulating plug having a plug body (hereinafter simply referred to as “plug”), and reference numeral 3 denotes an arc tube.

The arc tube 3 is fixedly supported on a front end X of the plug 2 by a metal lead support 4 and a metal support member 5. The metal lead support 4 extends forwardly from the plug 2, and is protected by an insulating sleeve 41. The metal support member 5 is fixedly secured to a front surface of the plug 2. The discharge lamp device 1 is formed by these constructions.

Specifically, an inner cylindrical portion 26, and an outer cylindrical portion 25, are formed at the front end X (see FIG. 3) of the plug 2. The inner cylindrical portion 26 has a base plate 53 provided at a front surface thereof, and is open. The outer cylindrical portion 25 has a focusing ring 24 mounted on a periphery thereof, and is open forwardly in surrounding relation to the inner cylindrical portion 26.

A lead wire 39b extends from the front end of the arc tube 3, and is fixedly secured by spot welding to a bent distal end portion 4a of the lead support 4. A rear end portion of the arc tube 3 is grasped by the metal perpendicularly-holding member 5, which includes a slide plate 51 and an arc-tube-grasping band 52, and which is fixedly welded to the base plate 53 provided at a front surface portion of the inner cylindrical portion 26.

The arc tube 3 includes a cylindrical shroud glass 32 and an arc tube body 31. The cylindrical shroud glass is also called an ultraviolet ray shielding globe, and is fused integrally to the arc tube body 31. The arc tube body 31 has a sealed glass bulb (also called a light emitting portion) 33 containing opposed electrodes 37a and 37b. Namely, in this structure, the shroud glass 32 encloses the sealed glass bulb 33 in a sealed manner. Reference numeral 34 denotes a discharge axis extending between the electrodes 37a and 37b.

The shroud glass 32 is made of silica glass that is doped with TiO₂ and CeO₂, and has an ultraviolet ray-shielding effect. That is, this shroud glass 32 positively cuts ultraviolet rays of a predetermined range, which are harmful to the human body, from light emitted from the sealed glass bulb 33 that serves as the discharge portion. The interior atmosphere of the shroud glass 32 is a vacuum, or inert gas is sealed in this shroud glass. Therefore, the shroud glass 32 is so designed as to perform a heat insulating effect against the radiation of heat from the sealed glass bulb 33 that serves as the discharge portion.

The arc tube body 31 is processed from a pipe-shaped silica glass tube, and has such a structure that the sealed glass bulb 33—in the form of an ellipsoid of revolution—is formed at a predetermined position in its longitudinal direction. Further, the sealed glass bulb 33 is interposed between pinch seal portions 38a and 38b having a rectangular transverse cross-section. Starter rare gas, mercury, and a metal halide (for example, sodium-scandium light emitting substance), are sealed in the sealed glass bulb 33.

Rectangular plate-like molybdenum foils 36a and 36b are sealed in the pinch seal portions 38a and 38b, respectively. Within the sealed glass bulb 33, the opposed tungsten electrodes 37a and 37b are disposed between the molybdenum foils 36a and 36b. And lead wires 39a and 39b, extending to the exterior of the arc tube body 31, are connected respectively to outer portions of the molybdenum foils 36a and 36b. The construction of the plug 2 will be described below.

Structure of the Insulating Plug

The focusing ring 24 is formed on the outer periphery of the front end portion X. Further, the focusing ring 24 forms an abutment reference surface f₁ (see FIG. 2), and is engaged in a bulb insertion hole 61 (see FIG. 2) in a reflector 6 of an automotive headlamp (not shown).

A lamp-side connector C₂ is formed integrally at a rear end portion Y of the plug 2. To the lamp-side connector C₂ can be attached and detached a power-supplying connector C₁ (see FIG. 2). The power-supplying connector C₁ contains a terminal of a power-supplying cord 7, which is electrically connected to a power source (not shown).

As set forth above, the plug 2 includes a portion that engages the bulb insertion hole 61, and also includes a portion relative to which the power-supplying connector C₁ can be attached and detached. Therefore, this plug 2 is required to have a high dimensional accuracy, and also is required to have rigidity.

An opening 29, in which a rear extension portion 3a (see FIG. 3) of the arc tube 3 can be inserted and received, is formed in the inner cylindrical portion 26 at the front end X of the plug 2. Also, the outer cylindrical portion 25, having the flange-like focusing ring 24 formed on the outer periphery thereof, is formed around the inner cylindrical portion 26. The metal base plate 53, forming a flat reference surface, is held in intimate contact with and fixedly secured to a cylindrical front end of the inner cylindrical portion 26.

A front surface of the base plate 53, which is integrally connected to the plug 2, forms a reference flat surface f₂ (see FIG. 2) disposed parallel to the reference flat surface f₁ (see FIG. 2) of the focusing ring 24. And the focusing ring 24 serves as a reference member for the positioning relative to the reflector 6.

The metal slide plate 51, and the metal arc tube-grasping band 52, are mounted on this base plate 53. The slide plate 51 and the grasping band 52 serve as the metal perpendicularly-holding member 5 for perpendicularly holding the shroud glass 32 of the arc tube 3. The arc tube's discharge axis 34 is disposed at a predetermined position on an extension line of the focusing ring's central axis 27 (see FIG. 2).

Namely, in the grasping band 52 includes a band body 52a, ear pieces 52b, and bent portions 52c. The ear pieces 52b are of a rectangular shape, are bent in an L-shape as viewed in cross-section, and are formed respectively at opposite ends of the curved band body 52a. As shown in FIG. 3, the ear pieces 52b are wound around the shroud glass 32, are mated with each other, and are spot welded together, thereby fixing the grasping band 52 around the shroud glass 32. Reference 52d denotes the spot welded portion.

The bent portions 52c are formed at two portions of the band body 52a in the longitudinal direction thereof. The resilient deformation of these bent portions 52c causes the bandbody 52a to expand and contract in the longitudinal direction. Therefore, the band body 52a can be wound around and fixed to the shroud glass 32.

A base surface 51a of the metal slide plate 51, forming the perpendicularly-holding member 5, is formed into a disk-like doughnut shape so as to mate with a base surface 53a of the base plate 53. Four leaf spring, tongue-shaped gripping pieces 51b are formed in an upstanding manner—by stamping—on an inner peripheral edge of the metal slide plate 51. Further, the gripping pieces 51b are disposed at equal intervals in the circumferential direction.

The outer periphery of the grasping band 52, fixedly wound around the shroud glass 32, is gripped by these tongue-shaped gripping pieces 51b, and is laser welded thereto. Reference numeral 51c denotes the laser welded portions. As a result, the arc tube 3 is integrally connected to the slide plate 51 in such a manner that the discharge axis 34 of the arc tube 3 is disposed perpendicular to a joint surface f₃ of the slide plate 51, joined to the base plate 53, and is spaced a predetermined distance from the joint surface f₃.

The round pipe-shaped insulating sleeve 41 of ceramics, through which the lead support 4 is passed, is inserted in a sleeve insertion hole 28 which is open to the front surface of the plug 2. An insertion end of the lead support 4, extending through the insulating sleeve 41, is laser welded to a predetermined portion of a bottom (not shown) of the sleeve insertion hole 28.

Material Composition of the Insulating Plug

As described above, the arrangement of the plug 2, the arc tube 3 and so on should be determined delicately and subtly. Therefore, during the molding of the plug 2, the precision of its configuration is important. At the same time, the configuration of the plug 2 is complicated as described above, so that ease of molding is required.

Further, the power-supplying connector C₁ is attached to, and detached from, the rear end portion Y of the plug 2. The plug 2 also is the member for being engaged in the bulb insertion hole 61 (see FIG. 2) in the reflector 6 of the automotive headlamp. Therefore, the plug is required to have high rigidity.

Furthermore, in the discharge lamp device 1 of the above construction, the plug 2 forms the base portion, and is provided in the vicinity of the arc tube 3 having the sealed glass bulb 33 serving as the light emitting portion. Therefore, this plug 2 is exposed to a high-temperature condition of about 220° C. because of heat generated by the light emitting portion. Also, a high voltage of about 20 kV is applied at the time of starting the lighting. Therefore, high heat resistance and voltage-withstanding properties are required for the plug 2. Moreover, even when the plug is used for a long period of time, deformation, cracking, dielectric breakdown, and so on, should not develop in the plug.

The plug 2 of the present invention is molded by, for example, injection molding. In consideration of the complicated shape of the plug 2, however, it is molded with a PPS synthetic resin, as a base material, which PPS resin enhances the plug's moldability.

From the viewpoint of enhancing the heat resistance and voltage-withstanding properties, a predetermined amount of glass fibers are added to the PPS resin. Namely, a glass-fiber-reinforced plastics material, containing the PPS resin as the base material, is suitable as the material for the plug 2.

It has been found through various studies, however, that the material composition must be arranged in further detail in order to obtain a plug 2 that can achieve an acceptable quality with respect to all of (1) heat resistance, (2) lifetime durability, (3) connector fitting strength (rigidity) and (4) dimensional accuracy (moldability).

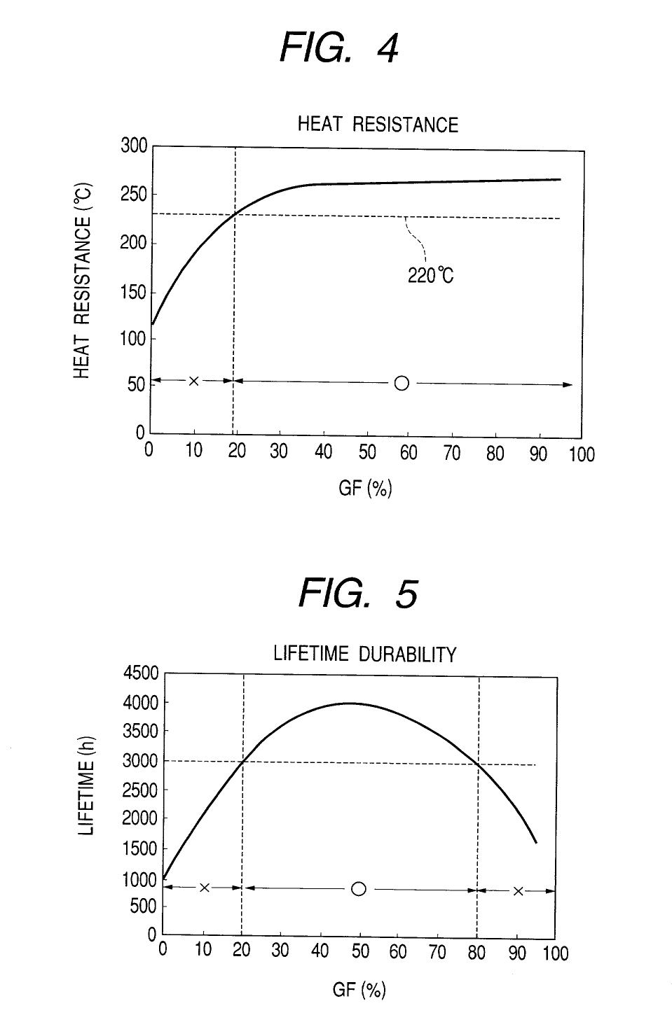

Therefore, the amount—based on weight %—of glass fibers in a PPS resin was changed so as to conduct detailed tests 1 to 4 in order to achieve acceptable quality for the above items (1) to (4). Description will be made below with reference to FIGS. 4 to 8 showing the results of these tests. (1) Test for Heat Resistance (Test 1)

Plugs 2, having respective glass fiber amounts (in weight %, referred to as “GF” in FIG. 4) of 5, 10, 15, 20, 30, 40, 50, 60, 70, 80 and 90% in PPS resin were prepared. Ten plugs 2 were prepared for each glass fiber amount, and the heat resistance test was conducted.

As shown in FIG. 4, plugs with a GF of not smaller than 20% did not have any abnormality in cracking, melting, deformation, looseness, or welding breakage. Further, it was found that a heat resistance of not smaller than 220° C. could be secured.

Incidentally, with respect to the glass fiber ratio of: 5%, 8 of 10 plugs 2 developed deformation defects; 10%, 5 of 10 plugs 2 developed deformation defects; and 15%, 3 of 10 plugs 2 developed deformation defects. Test 1 was conducted under conditions including an atmosphere temperature of 85° C. and a continuous lighting time of 500 hours.

(2) Test for Lifetime Durability (Test 2)

Using the same GF amounts in PPS resin as the glass fiber amounts described in Test 1, the lifetime durability test was conducted by a method of confirming whether or not cracking develops as a result of continuous lighting. Generally, the lifetime durability—required for the discharge device 1—should be such that deformation and so on will not occur even when the continuous lighting time exceeds 3000 hours.

As shown in FIG. 5, it was found that when the GF amount was in the range of between more than 20% and less than 80%, deformation and so on did not occur even when the continuous lighting time exceeded 3000 hours. Further, it was found that when the GF amount was in the range of between 40% and 60%, deformation and so on did not occur even when the continuous lighting time exceeded 3500 hours.

With respect to the glass fiber ratio of: 5%, the actual lighting time was 1786 hours; 10%, the actual lighting time was 2485 hours; 15%, the actual lighting time was 2733 hours; and 90%, the actual lighting time 2174 hours. In each of these cases, cracks were produced from voids.

(3) Test for Connector Fitting Strength (Rigidity) (Test 3)

Using the same GF amounts in PPS resin as the glass fiber amounts described in Test 1, the test for the connector fitting strength (rigidity) was conducted. Specifically, the plug 2 and the power-supply connector C₁ were fitted together. Then, they were twisted relative to one another with a torque wrench so as to measure a value of torque at which the plug 2 and the connector C₁ were broken apart. An acceptable level was set to not smaller than 3.0 N·m, and evaluation was effected.

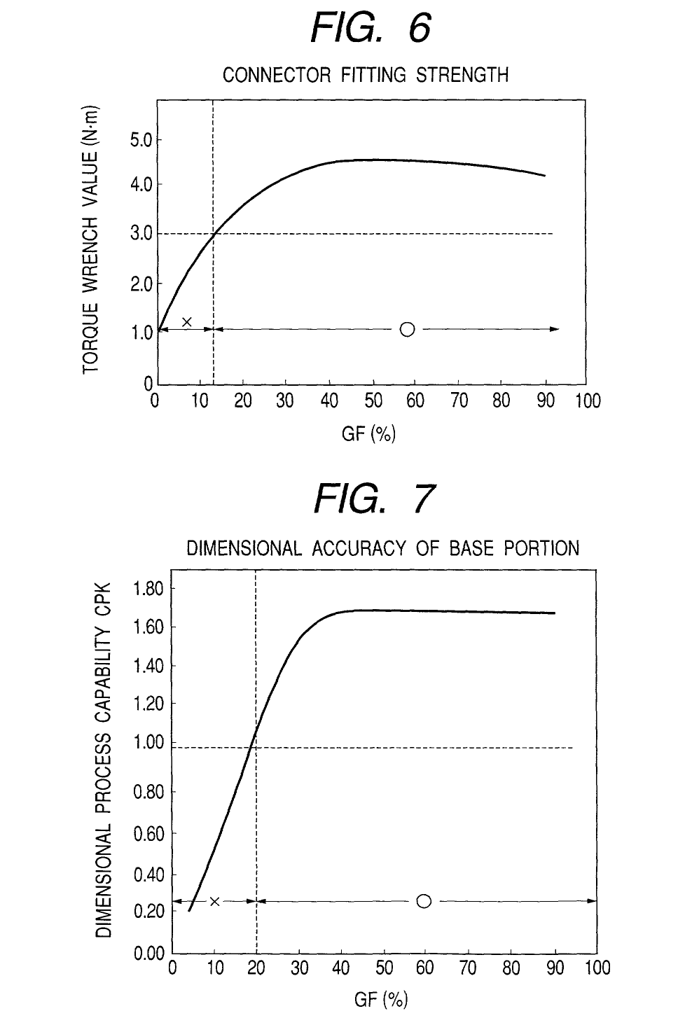

As shown in FIG. 6, it was found that when the GF was in the range of not smaller than 15%, the torque wrench value of not smaller than 3.0 N·m could be secured. It also was found that when the GF was in the range of between 40% and is 80%, the torque wrench value was particularly stable at around 4.5 N·m.

(4) Test for Dimensional Accuracy (Moldability) (Test 4)

Using the same GF amounts in PPS resin as the glass fiber amounts described in Test 1, the test for dimensional accuracy (moldability) was conducted. Generally, the dimensional accuracy (moldability) of a product can be accurately judged by process capability (CPK). Here, “process capability” indicates the degree of quality that is achieved when the process is standardized, and causes for abnormality are removed, whereby the process is kept in a stable condition.

Therefore, in this test, dimensions of various portions of the plugs 2 were measured using a micrometer and calipers. Dimensional errors of the plugs 2 for each GF amount were measured, and data were gathered. A histogram was prepared using these data, and a process capability index was calculated from a predetermined calculation formula. The number of samples, used in this test, was 30 for each GF amount.

As shown in FIG. 7, it was found that when the GF amount went below 20%, the process capability index became less than 1. Therefore, with respect to the dimensional accuracy (moldability) of the plug 2, the GF amount of not smaller than 20% is desired. Also, it was found that the process capability became stable at around 1.7 from the GF amount of 40% and greater, so that the dimensional accuracy became particularly stable.

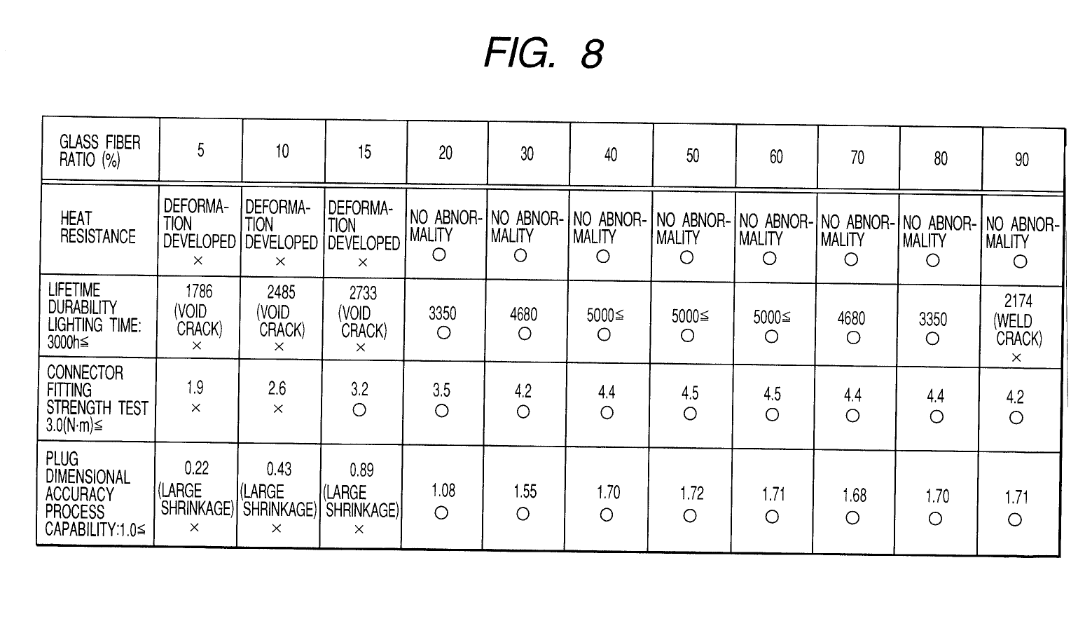

FIG. 8 is a chart collectively showing the results of the above Tests 1 to 4. As can be seen from FIG. 8, when the content of the glass fibers in the PPS resin was limited to the range of from 20 weight % to 80 weight %, all of: heat resistance; lifetime durability; connector fitting strength (rigidity); and dimensional accuracy; required for the insulating plug body, were all good. In FIG. 8, “O” indicates “very good”, “Δ” indicates “substantially good”, and “X” indicates “not good”.

According to the present invention, by forming the insulating plug body from the glass fiber reinforced plastic, the heat resistance, lifetime durability, connector fitting strength (rigidity), and dimensional accuracy, of the insulating plug body portion, which has heretofore been made of a single synthetic resin, can be enhanced. Further, cost reduction can be achieved at the same time.

By adopting a PPS resin as the base synthetic resin of the glass-fiber-reinforced plastics material according to the present invention, the plug's moldability and so on can be enhanced. Also, limiting the content of the glass fibers in the PPS resin to the predetermined range of from 20 wt % to 80 wt %, which is clearly critically significant, can achieve an overall durability as required for the insulating plug body. Further, the problems of lowered welding strength, and decreased moldability (dimensional accuracy), which are caused by an excess content of glass fibers, can be prevented.

Thus, the insulating plug of the present invention—as used for a discharge lamp device—achieves an improved overall durability, which has heretofore been unattained. Also, the cost of the insulating plug is reduced. Therefore, the discharge lamp device provided with the insulating plug of the present invention can achieve enhanced durability, and reduced cost. The present invention thus contributes to the wide use of discharge lamp devices.

The present invention is not limited to the specific above-described embodiments. It is contemplated that numerous modifications may be made to the insulating plug and discharge lamp device of the present invention without departing from the spirit and scope of the invention as defined in the following claims.

What is claimed is:

1. An insulating plug, for a discharge lamp device, comprising:
a body having a front end portion and a rear end portion;
an arc tube, fixedly held at the front end portion; and
a lamp-side connector provided at the rear end portion, wherein said lamp-side connector is arranged so that a power-supplying connector can be attached to and detached from said lamp-side connector,
wherein said body is made of a glass-fiber-reinforced plastic.

2. An insulating plug as set forth in claim 1, wherein said glass-fiber-reinforced plastic includes from 20 weight % to 80 weight % glass fibers contained in a polyphenylene sulfide resin.

3. A discharge lamp device provided with an insulating plug as defined in claim 1.

4. A discharge lamp device provided with an insulating plug as defined in claim 2.
